(19) United States
(12) Patent Application Publication
(10) Pub. No.: US 2026/0071089 A1
(43) Pub. Date: Mar. 12, 2026

(54) Ink Jet Composition Set

(71) Applicant: SEIKO EPSON CORPORATION, Tokyo (JP)

(72) Inventor: Ryota MIYASA, Matsumoto (JP)

(21) Appl. No.: 19/320,482

(22) Filed: Sep. 5, 2025

(30) Foreign Application Priority Data
Sep. 6, 2024 (JP) 2024-154067

(51) Int. Cl. C09D 11/54; C09D 11/38; C09D 11/40; D06P 5/30

(52) U.S. Cl. CPC C09D 11/54; C09D 11/38; C09D 11/40; D06P 5/30

(57) ABSTRACT

Provided is an ink jet composition set containing a coloring ink composition and a treatment liquid composition. The coloring ink composition contains a pigment, resin particles, a base compound A, and water. The treatment liquid composition contains an acid compound and water and may contain a base compound B. A molarity Ca1 (mol/kg) of an acidic group by the acid compound, a molarity Cb1 (mol/kg) of a basic group by the base compound A, and a molarity Cb2 (mol/kg) of a basic group by the base compound B satisfy a relation Ca1−(Cb1+1.5Cb2)≥0.10 (mol/kg).

The present application is based on, and claims priority from JP Application Serial Number 2024-154067, filed Sep. 6, 2024, the disclosure of which is hereby incorporated by reference herein in its entirety.

### BACKGROUND

### 1. Technical Field

The present disclosure relates to an ink jet composition set.

### 2. Related Art

An ink jet recording method can record high-definition images with a relatively simple apparatus and is rapidly developed in various fields. In the development, various studies are made on color developing properties, washing fastness, and the like. For example, WO 2023/042761 discloses an ink jet treatment liquid containing a water-soluble cationic polymer and an organic acid salt, in which the content of the water-soluble cationic polymer is 0.1 wt % or more and less than 10 wt % with respect to the entire treatment liquid.

By the way, when a treatment liquid composition obtained by a configuration in the related art such as WO 2023/042761 is used, there is room for improvement in the wet friction fastness of a textile printed matter to be obtained.

### SUMMARY

An ink jet composition set of the present disclosure is an ink jet composition set containing a treatment liquid composition and a coloring ink composition, wherein the treatment liquid composition contains an acid compound and water, the treatment liquid composition contains or does not contain a base compound A, the coloring ink composition contains a pigment, resin particles, a base compound B, and water, and a molarity Ca1 (mol/kg) of an acidic group by the acid compound, a molarity Cb1 (mol/kg) of a basic group by the base compound A, and a molarity Cb2 (mol/kg) of a basic group by the base compound B satisfy Expression (1) below:

Ca1−(Cb1+1.5Cb2)≥0.10(mol/kg) Expression (1)

where Ca1>0, Cb1≥0, and Cb2>0.

### BRIEF DESCRIPTION OF THE DRAWINGS

FIG. 1 is Table 1 showing the compositions of composition sets used in Examples and the evaluation results thereof.

FIG. 2 is Table 2 showing the compositions of composition sets used in Examples and the evaluation results thereof.

FIG. 3 is Table 3 showing the compositions of composition sets used in Examples and the evaluation results thereof.

FIG. 4 is Table 4 showing the compositions of composition sets used in Examples and the evaluation results thereof.

FIG. 5 is Table 5 showing the compositions of composition sets used in Examples and the evaluation results thereof.

FIG. 6 is Table 6 showing the compositions of composition sets used in Comparative Examples and the evaluation results thereof.

FIG. 7 is Table 7 showing the compositions of coloring ink compositions.

FIG. 8 is Table 8 showing the composition of clear ink compositions.

### DESCRIPTION OF EMBODIMENTS

An embodiment of the present disclosure (hereinafter referred to as “the present embodiment”) will be described below in detail with reference to the drawings as needed, but the present disclosure is not limited thereto, and various modifications can be made without departing from the gist thereof.

In the related art, an organic acid or a polyvalent metal salt is used as an aggregating agent for aggregating ink in a treatment liquid. The polyvalent metal salt has strong cohesive force, and tends to provide a recorded matter in which color developing properties and bleed-through are inhibited, but since the polyvalent metal salt is likely to generate aggregates that are easily dissolved in water in the vicinity of the surface of the recorded matter, the wet friction fastness of the recorded matter to be obtained tends to decrease. Meanwhile, it is known that the organic acid undergoes a neutralization reaction with an anion component in the ink, thereby reducing the hydrophilicity of the anion component, and thus a recorded matter having good wet friction fastness can be obtained.

By the way, even in the case of using the organic acid, in a mixed state of the treatment liquid composition and an ink composition, sufficient wet friction fastness may not be obtained depending on the concentration relation between an organic acid compound and a base compound that are subjected to a neutralization reaction, and thus detailed studies on the optimal neutralization reaction conditions have been required.

In the present disclosure, it has been found that in an ink jet composition set containing a coloring ink composition and a treatment liquid composition, when a molarity Ca1 of an acidic group by an acid compound contained in the treatment liquid composition, a molarity Cb2 of a base compound B contained in the coloring ink composition, and a molarity Cb1 of a basic group by a base compound A contained in the treatment liquid composition satisfy a condition of Expression (1) below, a recorded matter having excellent wet friction fastness is obtained.

Ca1−(Cb1+1.5Cb2)≥0.10(mol/kg) Expression (1)

This is due to the fact that the acid compound in the treatment liquid composition causes dispersion destruction of resin particles in the coloring ink composition, and aggregates with low solubility in water are easily formed. It is presumed that when the amount of the acidic group is made larger than a predetermined amount, dispersion destruction is promoted, and the amount of an ink component eluted from a printed matter during wet friction is reduced, thereby improving wet friction fastness.

On the other hand, however, the coloring ink composition may contain a base compound for the purpose of reducing skin irritation, improving storage stability, or the like. From the same viewpoint, the treatment liquid composition may also contain a base compound as needed. Since such a base compound reacts with the acid compound, the base compound easily competes with the reaction between the acid compound and the resin particles. Among base compounds, in particular, the base compound contained in the ink composition tends to have a large effect of hindering the role of the acid compound.

Given this, in the present embodiment, the amount of the acidic group is defined to be larger than a predetermined amount as in Expression (1) above. According to this, the amount of the acid compound large enough not to cause the dispersion destruction effect to be hindered by the base compound contained in the treatment liquid composition and the ink composition is defined. In addition, as described above, since the base compound contained in the ink composition has a large effect of hindering the role of the acid compound, this point is corrected by the coefficient for the molarity Cb2. According to this, it is considered that when Expression (1) above is satisfied, the recorded matter particularly has excellent wet friction fastness.

In the present specification, the term “acid” and “acid compound” refer to those having a pH of less than 7 when made into a 0.1% by mass aqueous solution at 25° C. In addition, the term “base” and “base compound” refer to those having a pH of greater than 7 when made into a 0.1% by mass aqueous solution at 25° C. Furthermore, in the ink composition, a compound contained as “chelating agent” is not treated as the acid compound in the present embodiment.

Each component contained in the ink jet composition set will be described below in detail.

### Ink Jet Composition Set

The ink jet composition set according to the present embodiment (hereinafter also simply referred to as “composition set”) contains a treatment liquid composition and a coloring ink composition, wherein the treatment liquid composition contains an acid compound and water, the treatment liquid composition contains or does not contain a base compound A, the coloring ink composition contains a pigment, resin particles, a base compound B, and water, and a molarity Ca1 (mol/kg) of an acidic group by the acid compound, a molarity Cb1 (mol/kg) of a basic group by the base compound A, and a molarity Cb2 (mol/kg) of a basic group by the base compound B satisfy Expression (1) below:

Ca1−(Cb1+1.5Cb2)≥0.10(mol/kg) Expression (1)

where Ca1>0, Cb1≥0, and Cb2>0.

In Expression (1), the value of Ca1−(Cb1+1.5Cb2) is preferably 0.10 or more and 8.0 or less. When the value of Ca1−(Cb1+1.5Cb2) is within the above range, the number of basic groups is prevented from becoming excessively small, and the effect of wet friction fastness according to the present disclosure tends to be exhibited more effectively and reliably. From the same viewpoint, the value of Ca1−(Cb1+1.5Cb2) is more preferably 0.15 or more and 7.0 or less, even more preferably 0.15 or more and 6.0 or less, even more preferably 0.15 or more and 5.0 or less, and even more preferably 0.40 or more and 3.0 or less.

### 1. Treatment Liquid Composition

The treatment liquid composition contained in the composition set is used by being caused to adhere to a recording medium, contains an acid compound and water, and may contain a base compound A as needed. In the composition set, one kind of the treatment liquid composition may be contained, or two or more kinds thereof may be contained. Note that the acid compound and the base compound A may partially form a neutralized salt in the treatment liquid composition.

The pH of the treatment liquid composition is preferably 1.5 or more and 7.0 or less. When the pH of the treatment liquid composition is within the above range, the effect of wet friction fastness according to the present disclosure tends to be exhibited more effectively and reliably. From the same viewpoint, the pH of the treatment liquid composition is more preferably 2.0 or more and 6.5 or less, even more preferably 2.5 or more and 6.5 or less, and still even more preferably 2.5 or more and 5.5 or less.

### 1.1. Acid Compound

Examples of the acid compound include an organic acid and an inorganic acid. The organic acid is preferably used from the viewpoint of making a textile printed matter have even better wet friction fastness and further improving irritation mitigating properties. One kind of the acid compound may be used alone, or two or more kinds thereof may be used in combination.

The acid compound preferably has a pKa in water at 25° C. of 2.0 or more and 7.0 or less. When the pKa of the acid compound in water at 25° C. is within the above range, buffering ability can be exhibited in a pH range of 2.5 to 6.5, and a neutralization ratio with the base compound A can be reduced to a lower level, and as a result, the textile printed matter has excellent wet friction fastness, and further irritation mitigating properties tend to improve. From the same viewpoint, the pKa of the acid compound at 25° C. is more preferably 2.2 or more and 6.5 or less, even more preferably 2.5 or more and 6.0 or less, and still even more preferably 2.8 or more and 5.8 or less.

In the present specification, “a compound having its pKa within a certain range” means that when the compound has a single pKa, the pKa is within a predetermined range, and when the compound has a plurality of pKa, at least one pKa is within the corresponding range.

Preferred examples of the acid compound include lactic acid, malonic acid, citric acid, adipic acid, succinic acid, malic acid, levulinic acid, phosphoric acid, glutaric acid, polyacrylic acid, acetic acid, glycolic acid, maleic acid, ascorbic acid, fumaric acid, tartaric acid, sulfonic acid, orthophosphoric acid, pyrrolidonecarboxylic acid, pyronecarboxylic acid, pyrrolecarboxylic acid, furancarboxylic acid, pyridinecarboxylic acid, coumaric acid, thiophenecarboxylic acid, nicotinic acid, derivatives of these compounds, and salts of these compounds. Among these, it is preferably one or more selected from the group consisting of lactic acid, acetic acid, malonic acid, citric acid, adipic acid, succinic acid, malic acid, levulinic acid, glutaric acid, dimethylolpropionic acid, propionic acid, and phosphoric acid, more preferably one or more selected from the group consisting of lactic acid, acetic acid, levulinic acid, malic acid, malonic acid, citric acid, glutaric acid, phosphoric acid, and dimethylolpropionic acid, and even more preferably one or more selected from the group consisting of lactic acid, levulinic acid, malic acid, malonic acid, citric acid, glutaric acid, phosphoric acid, and dimethylolpropionic acid. When such an acid compound is contained, the effect of improving wet friction fastness according to the present disclosure tends to be exhibited more effectively and reliably.

In the treatment liquid composition, the mass molarity Ca1 (mol/kg) of the acidic group derived from the acid compound is preferably 0.20 or more and 5.00 or less. When Ca1 is within the above range, the effect of improving wet friction fastness according to the present disclosure tends to be exhibited more effectively and reliably. From the same viewpoint, Ca1 (mol/kg) is more preferably 0.30 or more and 4.75 or less, more preferably 0.35 or more and 4.75 or less, even more preferably 0.40 or more and 3.50 or less, and even more preferably 0.50 or more and 3.50 or less.

The content of the acid compound on a mass basis is preferably 1.0 to 50% by mass, 2.0 to 40% by mass, 3.5 to 30% by mass, or 4.0 to 15% by mass with respect to the total amount of the treatment liquid composition. When the content of the acid compound on a mass basis is within the above range, the effect of improving wet friction fastness according to the present disclosure tends to be exhibited more effectively and reliably.

### 1.2. Base Compound A

The treatment liquid composition may or may not contain the base compound A. Examples of the base compound A include an organic base and an inorganic base. The organic base and the inorganic base are preferably a metal hydroxide or an amine compound. By using such a base compound A, the effect of improving wet friction fastness according to the present disclosure tends to be exhibited more effectively and reliably. In addition, by using such a base compound A, the solubility of the base compound A in water tends to be better. From the same viewpoint, the base compound A is more preferably an alkaline metal hydroxide, an alkaline earth metal hydroxide, or an amine compound, and even more preferably an alkaline earth metal hydroxide or an amine compound. Note that one kind of the base compound A may be used alone, or two or more kinds thereof may be used in combination.

The base compound A preferably contains one or more hydroxides of a metal selected from the group consisting of Li, Na, and K or an amine compound containing 1 to 10 nitrogen atoms in the molecule, and preferably contains one or more hydroxides of a metal selected from the group consisting of Li, Na, and K or an amine compound containing 1 to 6 nitrogen atoms in the molecule. In particular, by using such a base compound, wet friction fastness, particularly wet friction fastness in a cotton cloth or the like tends to further improve.

The metal constituting the metal hydroxide is preferably one or more selected from the group consisting of Li, Na, K, Ca, Mg, and Al, and more preferably at least one of Na and K. By using such a metal hydroxide, the recorded matter tends to have even better wet friction fastness. From the same viewpoint, the metal hydroxide is one or more selected from the group consisting of LiOH, NaOH, KOH, Ca(OH)₂, Mg(OH)₂, and Al(OH)₃, and one or more selected from the group consisting of NaOH, KOH, Ca(OH)₂, Mg(OH)₂, and Al(OH)₃. By using such a metal hydroxide, the recorded matter tends to have even better wet friction fastness.

The amine compound is preferably one or more selected from the group consisting of an alkanol amine compound, a polyvalent amine compound, and a polyamine compound. By using such an amine compound, the recorded matter tends to have even better wet friction fastness.

Examples of the alkanol amine compound include triethanolamine, tripropanolamine, triisopropanolamine, and tributanolamine. Among these, triisopropanolamine is preferable from the viewpoint of more effectively and reliably improving the wet friction fastness of the recorded matter.

Examples of the polyvalent amine compound include diethylenetriamine, dipropylenetriamine, dihexylenetriamine, triethylenetetramine, tetraethylenepentamine, pentaethylenehexamine, and hexaethyleneheptamine. Among these, dipropylenetriamine is preferable from the same viewpoint as described above.

The polyamine compound may be any compound having an amino group in the structure, and examples thereof include a polyamine resin, a polyamide resin, and a polyallylamine resin.

As the polyamine compound, commercially available products corresponding to the base compound in the present specification may be used. Examples of commercially available products of the polyamine compound include PAA-SA, PAA-01, 03, 05, 08, 15, 15C, 25, PAA-H-10C, PAA-D11-HCL, PAA-D41-HCL, PAA-D19-HCL, PAS-21CL, 22SA, 92, 92A, PAS-M-1, 1L, 1A, PAS-H-1L, 5L, 10L, PAS-J-81, and 81L (all are trade names, manufactured by Nittobo Medical Co., Ltd.), FL-14 (manufactured by SNF), Arafix 100, 251S, 255, and 255LOX (manufactured by Arakawa Chemical Industries, Ltd.), DK-6810, 6853, and 6885, WS-4010, 4011, 4020, 4024, 4027, and 4030 (manufactured by Seiko PMC Corporation), Papyogen P-105 (manufactured by Senka Corporation), Sumirez Resin 650 (30), 675A, 6615, and SLX-1 (manufactured by Taoka Chemical Co., Ltd.), Catiomaster (registered trademark) PD-1, 7, 30, A, PDT-2, PE-10, PE-30, DT-EH, EPA-SK01, and TMHMDA-E (manufactured by Yokkaichi Chemical Co., Ltd.), and Jetfix 36N, 38A, N700, and 5052 (manufactured by Satoda Chemical Industrial Co., Ltd.). Among these, PAA 03 is preferable from the viewpoint of more effectively and reliably improving the wet friction fastness of the recorded matter.

Examples of the polyallylamine resin include a polyallylamine hydrochloride, a polyallylamineamide sulfate, an allylamine hydrochloride/diallylamine hydrochloride copolymer, an allylamine acetate/diallylamine acetate copolymer, an allylamine acetate/diallylamine acetate copolymer, an allylamine hydrochloride/dimethylallylamine hydrochloride copolymer, an allylamine/dimethylallylamine copolymer, a polydiallylamine hydrochloride, a polymethyldiallylamine hydrochloride, a polymethyldiallylamineamide sulfate, a polymethyldiallylamine acetate, a polydiallyldimethylammonium chloride, a diallylamine acetate/sulfur dioxide copolymer, a diallylmethylethylammonium ethylsulfate/sulfur dioxide copolymer, a methyldiallylamine hydrochloride/sulfur dioxide copolymer, a diallyldimethylammonium chloride/sulfur dioxide copolymer, and a diallyldimethylammonium chloride/acrylamide copolymer.

In the treatment liquid composition, the mass molarity Cb1 (mol/kg) of the basic group derived from the base compound A is preferably 0.00 or more and 3.00 or less. When Cb1 is within the above range, the effect of improving wet friction fastness according to the present disclosure tends to be exhibited more effectively and reliably. From the same viewpoint, Cb1 (mol/kg) is more preferably 0.01 or more and 2.50 or less, even more preferably 0.05 or more and 2.00 or less, even more preferably 0.05 or more and 1.50 or less, still even more preferably 0.10 or more and 1.75 or less, and still even more preferably 0.10 or more and 1.00 or less.

The content of the base compound A on a mass basis is preferably 0.0 to 40% by mass, 0.1 to 30% by mass, 0.5 to 20% by mass, 0.5 to 10% by mass, 1.0 to 10% by mass, or 1.0 to 5% by mass with respect to the total amount of the treatment liquid composition. When the content of the base compound A is within the above range, the effect of improving wet friction fastness according to the present disclosure tends to be exhibited more effectively and reliably.

### 1.3. Water-Soluble Organic Solvent

The treatment liquid composition may contain a water-soluble organic solvent. The organic solvent is not limited so long as it is water-soluble, and examples thereof include polyhydric alcohols, glycol ethers, nitrogen-containing solvents, ethers, and cyclic esters. Among these, polyhydric alcohols are preferable from the viewpoint of more effectively and reliably improving the wet friction fastness of the recorded matter. One kind of the water-soluble organic solvent may be used alone, or two or more kinds thereof may be used in combination.

Polyhydric alcohols can be classified into, for example, polyols and a diol compound. Specific examples of polyols include glycerin, ethylene glycol, propylene glycol, 1,2-propanediol, 1,2-butanediol, 1,3-propanediol, 1,4-butanediol, diethylene glycol, triethylene glycol, dipropylene glycol, and trimethylolpropane. Among these, from the viewpoint of more effectively and reliably improving the wet friction fastness of the recorded matter, one or more selected from the group consisting of glycerin, propylene glycol, and triethylene glycol are preferably contained.

In addition, specific examples of the diol compound include 1,2-pentanediol, 1,2-hexanediol, 1,2-octanediol, 1,6-hexanediol, 2-methyl-2,4-pentanediol, 2-ethyl-2-methyl-1,3-propanediol, 2-methyl-2-propyl-1,3-propanediol, 2-methyl-1,3-propanediol, 2,2-dimethyl-1,3-propanediol, 3-methyl-1,3-butanediol, 2-ethyl-1,3-hexanediol, 3-methyl-1,5-pentanediol, and 2-methylpentane-2,4-diol. Among these, 1,2-hexanediol is preferably used from the viewpoint of more effectively and reliably improving the wet friction fastness of the recorded matter.

Further, specific examples of compounds of glycol ethers include triethylene glycol monobutyl ether, ethylene glycol monomethyl ether, ethylene glycol monoethyl ether, ethylene glycol monopropyl ether, ethylene glycol monobutyl ether, ethylene glycol monomethyl ether acetate, diethylene glycol monomethyl ether, diethylene glycol monoethyl ether, diethylene glycol monopropyl ether, diethylene glycol monobutyl ether, diethylene glycol mono-t-butyl ether, 1-methyl-1-methoxybutanol, propylene glycol monomethyl ether, propylene glycol monoethyl ether, propylene glycol monopropyl ether, propylene glycol monobutyl ether, dipropylene glycol monomethyl ether, dipropylene glycol monoethyl ether, dipropylene glycol monopropyl ether, propylene glycol monobutyl ether, dipropylene glycol monobutyl ether, 3-methoxy-3-methyl-1-butanol, ethylene glycol dimethyl ether, ethylene glycol diethyl ether, ethylene glycol dibutyl ether, diethylene glycol dimethyl ether, and diethylene glycol diethyl ether. Among these, triethylene glycol monobutyl ether is preferably used from the viewpoint of more effectively and reliably improving the wet friction fastness of the recorded matter.

The content of the water-soluble organic solvent is preferably 5 to 50% by mass, 10 to 40% by mass, or 12 to 30% by mass with respect to the total amount of the treatment liquid composition. When the content of the water-soluble organic solvent is within the above range, the recorded matter tends to have even better wet friction fastness.

From the same viewpoint, the content of polyhydric alcohols or glycol ethers is preferably 5 to 50% by mass, 10 to 40% by mass, or 12 to 30% by mass with respect to the total amount of the treatment liquid composition.

### 1.4. Surfactant

The treatment liquid composition may contain a surfactant. Examples of the surfactant include a nonionic surfactant, an anionic surfactant, and an amphoteric surfactant. From the viewpoint of more effectively and reliably improving ejection stability when the treatment liquid composition is ejected by an ink jet method, the nonionic surfactant is preferable. The nonionic surfactant is preferable also in that it tends to be stable even in the treatment liquid composition containing an acid compound and a base compound. One kind of the surfactant may be used alone, or two or more kinds thereof may be used in combination.

Examples of the nonionic surfactant include an acetylene glycol-based surfactant, an alcohol ethoxylate-based surfactant, a fluorine-based surfactant, and a silicone-based surfactant.

The acetylene glycol-based surfactant is not particularly limited, and examples thereof include one or more selected from 2,4,7,9-tetramethyl-5-decyne-4,7-diol and an alkylene oxide adduct of 2,4,7,9-tetramethyl-5-decyne-4,7-diol, and 2,4-dimethyl-5-decyn-4-ol and an alkylene oxide adduct of 2,4-dimethyl-5-decyn-4-ol.

Examples of commercially available products of the acetylene glycol-based surfactant include the Olfine 104 series and the E series such as Olfine E1010 (trade names, manufactured by Air Products and Chemicals, Inc.), and Surfynol 61, 104, and 465 (trade names, manufactured by Nissin Chemical Co., Ltd.). Among these, Surfynol 465 is preferable from the viewpoint of more effectively and reliably exhibiting the effect of wet friction fastness according to the present disclosure.

The alcohol ethoxylate-based surfactant is a compound in which a polyoxyethylene chain and an alkyl group are bonded to each other by an ether bond, can be represented by a molecular formula “R_{A}—O—(CH₂CH₂O)_{d}—H,” and may also be referred to as a poly(oxyethylene) alkyl ether.

Examples of the alcohol ethoxylate-based surfactant include CL-40, CL-50, CL-70, CL-85, CL-95, CL-100, CL-120, CL-140, CL-160, CL-200, and CL-400 (trade names, manufactured by Sanyo Chemical Industries, Ltd.).

The fluorine-based surfactant is not particularly limited, and examples thereof include a perfluoroalkyl sulfonate, a perfluoroalkyl carboxylate, a perfluoroalkyl phosphonate, a perfluoroalkyl ethylene oxide adduct, a perfluoroalkyl betaine, and a perfluoroalkyl amine oxide compound.

Examples of the silicone-based surfactant include a polysiloxane-based compound and a polyether-modified organosiloxane, and examples of commercially available products thereof include BYK-306, BYK-307, BYK-333, BYK-341, BYK-345, BYK-346, BYK-347, BYK-348, and BYK 349 (all are trade names, manufactured by BYK Japan K.K.), KF-351A, KF-352A, KF-353, KF-354L, KF-355A, KF-615A, KF-945, KF-640, KF-642, KF-643, KF-6020, X-22-4515, KF-6011, KF-6012, KF-6015, and KF 6017 (all are trade names, manufactured by Shin-Etsu Chemical Co., Ltd.).

The content of the surfactant is preferably 0.01 to 3.0% by mass, 0.03 to 1.0% by mass, or 0.05 to 0.1% by mass with respect to the total amount of the treatment liquid composition. When the content of the surfactant is within the above range, the effect of wet friction fastness according to the present disclosure can be exhibited more effectively and reliably.

### 1.5 Water

The treatment liquid composition contains water. As water, water from which ionic impurities are removed as much as possible is preferable, and examples of such water include pure water such as ion exchanged water, reverse osmosis water, and distilled water, and ultrapure water.

### 1.6. Other Components

The treatment liquid composition may contain, as needed, various additives such as a pH adjuster, a chelating agent, a softener, a dissolution aid, a viscosity modifier, an ultraviolet absorber, an antioxidant, and a corrosion inhibitor, as components other than those described above. The treatment liquid composition is not an ink, and is not intended for coloring by itself.

### 2. Coloring Ink Composition

The coloring ink composition contained in the composition set contains a pigment, resin particles, a base compound B, and water. The coloring ink composition may be caused to adhere to the recording medium to which the treatment liquid composition has adhered, or may be caused to adhere to the recording medium simultaneously with the treatment liquid composition. Alternatively, the treatment liquid composition may be caused to adhere to a recording medium to which the coloring ink composition has adhered. From the viewpoint of more effectively and reliably exhibiting the effect of wet friction fastness according to the present disclosure, the coloring ink composition is preferably caused to adhere to the recording medium simultaneously with the treatment liquid composition.

The pH of the coloring ink composition is preferably greater than 6.5. When the pH of the coloring ink composition is within the above range, the storage stability of the coloring ink composition is good, and the effect of wet friction fastness according to the present disclosure tends to be exhibited more effectively and reliably. The upper limit of the pH of the coloring ink composition is not particularly limited, and may be 13 or less, 12.5 or less, or 12 or less.

### 2.1. Pigment

As the pigment, an anionic dispersed pigment is preferably contained. The anionic dispersed pigment is dispersed by neutralizing an acidic group with a base, and the acidic group of the dispersed pigment, which is a relatively weak acid, is liberated by the acid compound in the treatment liquid composition, the solubility decreases, and wet friction fastness tends to improve.

In the coloring ink composition, examples of the dispersed pigment include a self-dispersible pigment and a resin-dispersed pigment. From the viewpoint of facilitating the progress of the reaction with the treatment liquid composition, the self-dispersible pigment is preferably used.

Specific examples of the pigment include an inorganic pigment and an organic pigment. As the inorganic pigment, in addition to titanium oxide and iron oxide, carbon black produced by a known method such as the contact method, the furnace method, or the thermal method can be used. On the other hand, as the organic pigment, for example, an azo pigment, a polycyclic pigment, a nitro pigment, a nitroso pigment, aniline black, and the like can be used. Examples of the azo pigment include an azo lake, an insoluble azo pigment, a condensed azo pigment, and a chelate azo pigment.

Examples of the carbon black pigment include C.I. (Colour Index Generic Name) Pigment Black 1, 7, and 11. Commercially available products of carbon blacks may be used, and examples thereof include No. 2300, No. 900, MCF88, No. 33, No. 40, No. 45, No. 52, MA7, MA8, MA100, No. 2200B, and the like from Mitsubishi Chemical Corporation; Raven (registered trademark) 5750, 5250, 5000, 3500, 1255, 700, and the like from Columbia Carbon Inc.; Regal (registered trademark) 400R, 330R, and 660R, Mogul (registered trademark) L, Monarch (registered trademark) 700, 800, 880, 900, 1000, 1100, 1300, 1400, and the like from Cabot Corporation; and Color Black FW1, FW2, FW2V, FW18, FW200, S150, S160, and S170, Printex (registered trademark) 35, U, V, and 140U, Special Black 6, 5, 4A, 4, and the like from Degussa AG. In addition, pigments obtained by the preparation method described in Examples described below may be used.

The content of the pigment in the coloring ink composition is preferably 1 to 10% by mass, 2 to 8% by mass, or 3 to 7% by mass with respect to the total amount of the coloring ink composition. When the content of the pigment is within the above range, the effect according to the present disclosure can be exhibited more effectively and reliably. Note that the content of the pigment in the coloring ink composition is based on % by mass of the solid content of the pigment.

### 2.2. Resin Particles

Examples of the resin particles include anionic resin particles, nonionic resin particles, and cationic resin particles. Among the resin particles, anionic resin particles are preferable from the viewpoint of more effectively and reliably exhibiting the effect of wet friction fastness according to the present disclosure. Examples of the anionic group contained in the anionic resin particles include a sulfonic acid group, a carboxylic acid group, a phosphoric acid group, and a hydroxy group, and an acidic group is preferable. By the resin particles having an acidic group, the effect according to the present disclosure tends to be exhibited more effectively and reliably. Note that the resin particles are particles containing a resin, and although any resin particles that are in an emulsion state and a solution state can be used, it is preferable to use resin particles in an emulsion state from the viewpoint of inhibiting an increase in the viscosity of the ink.

The anionic resin particles are not limited so long as they have an anionic group, and specific examples thereof include a urethane resin, a polycarbonate resin, a (meth)acrylic resin, a styrene resin, a silicone resin, a styrene acrylic resin, a fluorene resin, a polyolefin resin, a rosin-modified resin, a terpene resin, a polyester resin, a polyamide resin, an epoxy resin, a vinyl chloride resin, a vinyl chloride-vinyl acetate copolymer, and an ethylene-vinyl acetate resin. Among these, a styrene acrylic resin or a urethane resin is preferable, and a urethane resin is more preferable from the viewpoint of more effectively and reliably exhibiting the effect according to the present disclosure.

The content of the resin particles in the coloring ink composition is preferably 1 to 10% by mass, 2 to 8% by mass, or 3 to 7% by mass with respect to the total amount of the coloring ink composition. When the content of the resin particles is within the above range, the effect according to the present disclosure can be exhibited more effectively and reliably. From the same viewpoint, the content of the anionic resin particles in the coloring ink composition is preferably 1 to 10% by mass, 2 to 8% by mass, or 3 to 7% by mass with respect to the total amount of the coloring ink composition. Note that the content is based on % by mass of the solid content of the resin particles.

### 2.3. Base Compound B

Examples of the base compound B include an organic base and an inorganic base. The organic base and the inorganic base are preferably a metal hydroxide or an amine compound. By using the metal hydroxide or the amine compound, the recorded matter tends to have even better wet friction fastness. One kind of the base compound B may be used alone, or two or more kinds thereof may be used in combination.

Specific examples of compounds of the base compound B include the same compounds as the metal hydroxides and the amine compounds in the base compound A described above. Among them, at least one of potassium hydroxide and triethanolamine is preferably contained from the viewpoint of more effectively and reliably exhibiting the effect of wet friction fastness according to the present disclosure.

In the coloring ink composition, the mass molarity Cb2 (mol/kg) of the basic group derived from the base compound B is preferably 0.00 or more and 3.00 or less. When Cb2 is within the above range, the effect of improving wet friction fastness according to the present disclosure tends to be exhibited more effectively and reliably. From the same viewpoint, Cb2 (mol/kg) is more preferably 0.001 or more and 2.50 or less, and even more preferably 0.005 or more and 2.00 or less.

The content of the base compound B on a mass basis is preferably 0.0 to 10% by mass, 0.05 to 5% by mass, 0.1 to 3.5% by mass, or 0.5 to 3.0% by mass with respect to the total amount of the coloring ink composition. When the content of the base compound B is within the above range, the effect of improving wet friction fastness according to the present disclosure tends to be exhibited more effectively and reliably.

### 2.4. Water-Soluble Organic Solvent

The coloring ink composition may contain a water-soluble organic solvent. The organic solvent used in the coloring ink composition is not limited so long as it is water-soluble, and examples thereof include those exemplified in the treatment liquid composition described above. Among these, from the viewpoint of more effectively and reliably improving the wet friction fastness of the recorded matter, polyhydric alcohols are preferable, and at least one of glycerin and 1,2-hexanediol is more preferably used. Note that one kind of the organic solvent may be used alone, or two or more kinds thereof may be used in combination.

The content of the organic solvent in the coloring ink composition is preferably 5 to 40% by mass, 10 to 30% by mass, or 12 to 25% by mass with respect to the total amount of the coloring ink composition. When the content of the organic solvent is within the above range, the recorded matter tends to have even better wet friction fastness.

### 2.5. Surfactant

The coloring ink composition may contain a surfactant. Examples of the surfactant used in the coloring ink composition include the surfactants exemplified in the treatment liquid composition described above. Among such surfactants, an acetylene glycol-based surfactant is preferable from the viewpoint of more effectively and reliably exhibiting the effect of wet friction fastness according to the present disclosure, and Surfynol 465 is preferable as a commercially available product thereof. Note that one kind of the surfactant may be used alone, or two or more kinds thereof may be used in combination.

The content of the surfactant is preferably 0.1 to 3.0% by mass, 0.2 to 2.0% by mass, or 0.3 to 1.0% by mass with respect to the total amount of the coloring ink composition. When the content of the surfactant is within the above range, the effect of wet friction fastness according to the present disclosure can be exhibited more effectively and reliably.

### 2.6. Chelating Agent

The coloring ink composition may contain a chelating agent. Examples of the chelating agent used in the coloring ink composition include disodium dihydrogen ethylenediaminetetraacetate (EDTA2Na), ethylenediaminetetraacetate (EDTA), nitrilotriacetate of ethylenediamine, hexametaphosphate, pyrophosphate, and metaphosphate. Disodium dihydrogen ethylenediaminetetraacetate (EDTA2Na) is preferable from the viewpoint of more effectively and reliably exhibiting the effect of wet friction fastness according to the present disclosure.

The content of the chelating agent is preferably 0.001 to 0.5% by mass, 0.005 to 0.3% by mass, or 0.01 to 0.1% by mass with respect to the total amount of the coloring ink composition. When the content of the chelating agent is within the above range, the effect of wet friction fastness according to the present disclosure can be exhibited more effectively and reliably.

### 2.7. Water

As water, water from which ionic impurities are removed as much as possible is preferable, and examples of such water include pure water such as ion exchanged water, reverse osmosis water, and distilled water, and ultrapure water.

### 2.8. Other Components

As components other than those described above, for example, various additives such as a pH adjuster, a softener, a dissolution aid, a viscosity modifier, an ultraviolet absorber, an antioxidant, and a corrosion inhibitor may be contained as needed.

### 3. Clear Ink Composition

The composition set may further contain a clear ink composition. The clear ink composition is a composition that contains resin particles, a base compound C, and water, and does not substantially contain a coloring material. When the composition set further contains the clear ink composition, the wet friction fastness of the recorded matter tends to further improve.

Note that the clear ink composition is not an ink used for coloring, but is used for the purpose of improving the abrasion resistance and adjusting the glossiness of the recorded matter, improving the fixability and the color developing properties of the color ink, and the like. Here, “not substantially containing a coloring material” means that the content of the coloring material is preferably 0.1% by mass or less, 0.05% by mass or less, or 0.01% by mass or less with respect to the total amount of the clear ink composition.

When the composition set contains the clear ink composition, Ca1, Cb1, Cb2, and a molarity Cb3 (mol/kg) of a basic group by the base compound C preferably satisfy Expression (2) below. When satisfying the relation of Expression (2), the effect of an aggregation reaction by the acid compound and the base compound in each composition can be optimized, and as a result, the wet friction fastness of the recorded matter, particularly wet friction fastness when a polyester cloth is used as the recording medium tends to further improve. Note that in Expression (2), the value of Ca1−(Cb1+1.5Cb2+1.5Cb3) is preferably 0.10 or more and 8.0 or less, more preferably 0.10 or more and 7.0 or less, and even more preferably 0.10 or more and 6.0 or less.

Ca1−(Cb1+1.5Cb2+1.5Cb3)≥0.10(mol/kg) Expression (2)

When the composition set contains the clear ink composition, Ca1, Cb1, Cb2, and Cb3 preferably satisfy Expression (4) below. When satisfying the relation of Expression (4), the effect of the aggregation reaction by the acid compound and the base compound in each composition can be optimized, and as a result, the wet friction fastness of the recorded matter, particularly wet friction fastness when a polyester cloth is used as the recording medium tends to further improve. Note that in Expression (4), the value of Ca1−(Cb1+1.5Cb2+1.5Cb3) is preferably 0.15 or more and 8.0 or less, more preferably 0.15 or more and 7.0 or less, and even more preferably 0.15 or more and 6.0 or less.

Ca1−(Cb1+1.5Cb2+1.5Cb3)≥0.15(mol/kg) Expression (4)

When the composition set contains the clear ink composition, Ca1, Cb1, Cb2, and Cb3 preferably satisfy Expression (3) below. When satisfying the relation of Expression (3), excessive formation of the neutralized salt is inhibited, and the wet friction fastness of the recorded matter on a polyester cloth tends to further improve. Note that in Expression (3), the value of {Ca1−(Cb1+1.5Cb2+1.5Cb3)}/1.5(Cb1+1.5Cb2+1.5Cb3) is preferably 0.01 or more and 150 or less, more preferably 0.01 or more and 130 or less, and even more preferably 0.01 or more and 10 or less.

{Ca1−(Cb1+1.5Cb2+1.5Cb3)}/1.5(Cb1+1.5Cb2+1.5Cb3)≥0.01 Expression (3)

When the composition set contains the clear ink composition, Ca1, Cb1, Cb2, and Cb3 preferably satisfy Expression (5) below. When satisfying the relation of Expression (5), excessive generation of the neutralized salt is inhibited, and the wet friction fastness of the recorded matter on a polyester cloth tends to further improve. Note that in Expression (5), the value of {Ca1−(Cb1+1.5Cb2+1.5Cb3)}/1.5(Cb1+1.5Cb2+1.5Cb3) is preferably 0.20 or more and 150 or less, more preferably 0.20 or more and 130 or less, and even more preferably 0.20 or more and 10 or less.

{Ca1−(Cb1+1.5Cb2+1.5Cb3)}/1.5(Cb1+1.5Cb2+1.5Cb3)≥0.20 Expression (5)

### 3.1. Resin Particles

As the resin particles, the same as the resin particles used in the coloring ink composition described above can be preferably used in the same manner.

The content of the resin particles in the clear ink composition is preferably 1 to 20% by mass, 5 to 15% by mass, or 8 to 12% by mass with respect to the total amount of the clear ink composition. When the content of the resin particles is within the above range, the effect according to the present disclosure can be exhibited more effectively and reliably. From the same viewpoint, the content of the anionic resin particles in the clear ink composition is preferably 1 to 20% by mass, 5 to 15% by mass, or 8 to 12% by mass with respect to the total amount of the clear ink composition. Note that the content is based on % by mass of the solid content of the resin particles.

### 3.2. Base Compound C

Examples of the base compound C include an organic base and an inorganic base. The organic base and the inorganic base are preferably a metal hydroxide or an amine compound. By using the metal hydroxide or the amine compound, the recorded matter tends to have even better wet friction fastness. One kind of the base compound C may be used alone, or two or more kinds thereof may be used in combination.

The base compound A, the base compound B, and the base compound C preferably contain one or more selected from an alkaline metal hydroxide, an alkaline earth metal hydroxide, and an amine compound. By using a set of compositions containing such a base compound, the effect of wet friction fastness according to the present disclosure tends to be exhibited more effectively and reliably.

As specific compounds of the base compound C, the same compounds as the metal hydroxides and the amine compounds in the base compound A described above can be used. Among them, at least one of potassium hydroxide and triethanolamine is preferably contained from the viewpoint of more effectively and reliably exhibiting the effect of wet friction fastness according to the present disclosure.

In the clear ink composition, the mass molarity Cb3 (mol/kg) of the basic group derived from the base compound C is preferably 0.000 or more and 3.00 or less. When Cb3 is within the above range, the effect of improving wet friction fastness according to the present disclosure tends to be exhibited more effectively and reliably. From the same viewpoint, Cb3 (mol/kg) is more preferably 0.001 or more and 2.50 or less, and even more preferably 0.005 or more and 2.00 or less.

When the composition set contains the clear ink composition, Cb2 and Cb3 are each preferably 0.35 mol/kg or less. When Cb2 and Cb3 are within the above range, the wet friction fastness of the recorded matter tends to further improve. From the same viewpoint, Cb2 and Cb3 are each more preferably 0.30 mol/kg or less, and even more preferably 0.25 mol/kg or less.

The content of the base compound C on a mass basis is preferably 0.0 to 10% by mass, 0.01 to 5% by mass, or 0.011 to 3.7% by mass with respect to the total amount of the clear ink composition. When the content of the base compound C is within the above range, the effect of improving wet friction fastness according to the present disclosure tends to be exhibited more effectively and reliably.

### 3.3. Water-Soluble Organic Solvent

The clear ink composition may contain a water-soluble organic solvent. The organic solvent used in the clear ink composition is not limited so long as it is water-soluble, and examples thereof include those exemplified in the treatment liquid composition described above. Among them, from the viewpoint of more effectively and reliably improving the wet friction fastness of the recorded matter, polyhydric alcohols are preferable, and at least one of glycerin and 1,2-hexanediol is more preferably used. Note that one kind of the organic solvent may be used alone, or two or more kinds thereof may be used in combination.

The content of the organic solvent in the clear ink composition is preferably 5 to 40% by mass, 10 to 30% by mass, or 15 to 25% by mass with respect to the total amount of the clear ink composition. When the content of the organic solvent is within the above range, the recorded matter tends to have even better wet friction fastness.

### 3.4. Surfactant

The clear ink composition may contain a surfactant. Examples of the surfactant include the surfactants used in the treatment liquid composition described above. Among such surfactants, an acetylene glycol-based surfactant is preferable from the viewpoint of more effectively and reliably exhibiting the effect of wet friction fastness according to the present disclosure, and Surfynol 465 is preferable as a commercially available product thereof. Note that one kind of the surfactant may be used alone, or two or more kinds thereof may be used in combination.

The content of the surfactant is preferably 0.1 to 3.0% by mass, 0.2 to 2.0% by mass, or 0.3 to 1.0% by mass with respect to the total amount of the clear ink composition. When the content of the surfactant is within the above range, the effect of wet friction fastness according to the present disclosure can be exhibited more effectively and reliably.

### 3.5. Chelating Agent

The clear ink composition may contain a chelating agent. Examples of the chelating agent used in the clear ink composition include disodium dihydrogen ethylenediaminetetraacetate (EDTA2Na), ethylenediaminetetraacetate (EDTA), nitrilotriacetate of ethylenediamine, hexametaphosphate, pyrophosphate, and metaphosphate. Disodium dihydrogen ethylenediaminetetraacetate (EDTA2Na) is preferable from the viewpoint of more effectively and reliably exhibiting the effect of wet friction fastness according to the present disclosure.

The content of the chelating agent is preferably 0.001 to 0.5% by mass, 0.005 to 0.3% by mass, or 0.01 to 0.1% by mass with respect to the total amount of the clear ink composition. When the content of the chelating agent is within the above range, the effect of wet friction fastness according to the present disclosure can be exhibited more effectively and reliably.

### 3.6. Water

As water, water from which ionic impurities are removed as much as possible is preferable, and examples of such water include pure water such as ion exchanged water, reverse osmosis water, and distilled water, and ultrapure water.

### 3.7. Other Components

As components other than those described above, for example, various additives such as a pH adjuster, a softener, a dissolution aid, a viscosity modifier, an ultraviolet absorber, an antioxidant, and a corrosion inhibitor may be contained as needed.

### 4. Method for Preparing Each Composition

As a method for preparing each composition, for example, each composition can be prepared by mixing components in any order, and removing impurities, foreign substances, and the like by performing filtration or the like as needed. As a method for mixing the components, a method of sequentially adding the components into a container equipped with a stirring device such as a mechanical stirrer or a magnetic stirrer, and performing stirring and mixing is used. Examples of the filtration method include centrifugal filtration and filter filtration. In addition, the method used in Examples described below may be used.

### EXAMPLES

The present disclosure will be described below more specifically with reference to Examples and Comparative Examples. The present disclosure is not limited by Examples below in any way.

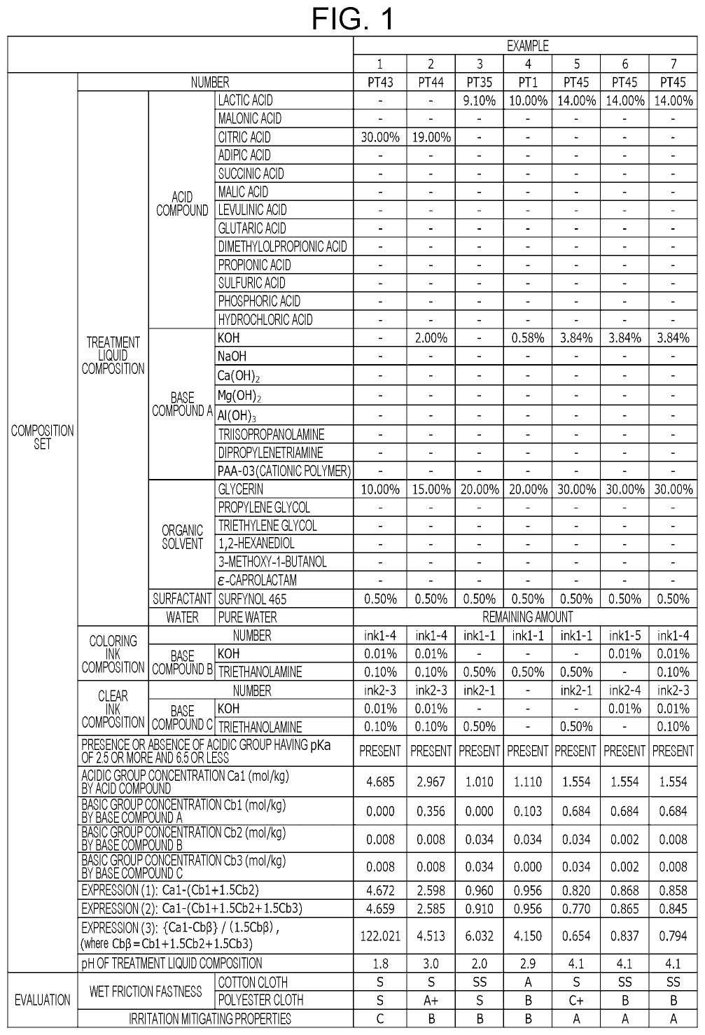

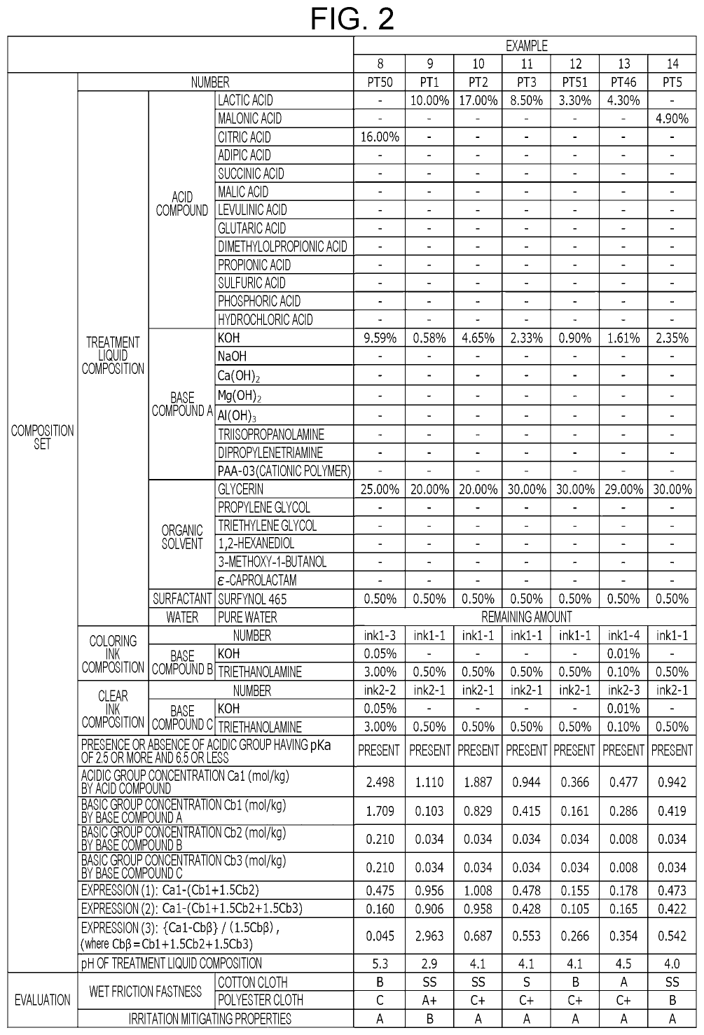

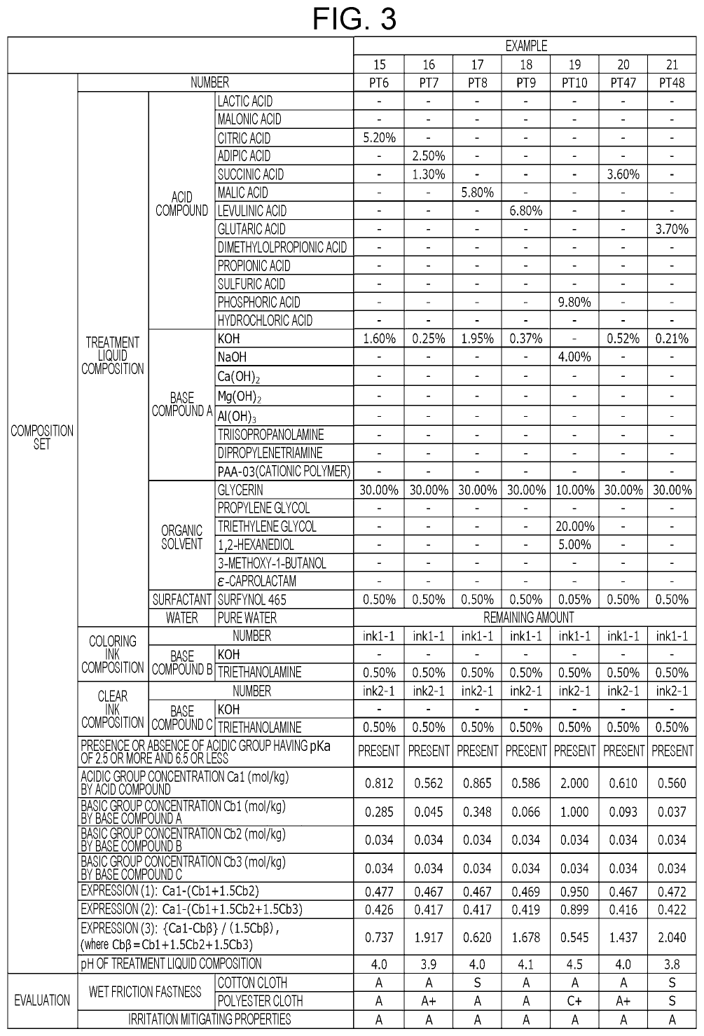

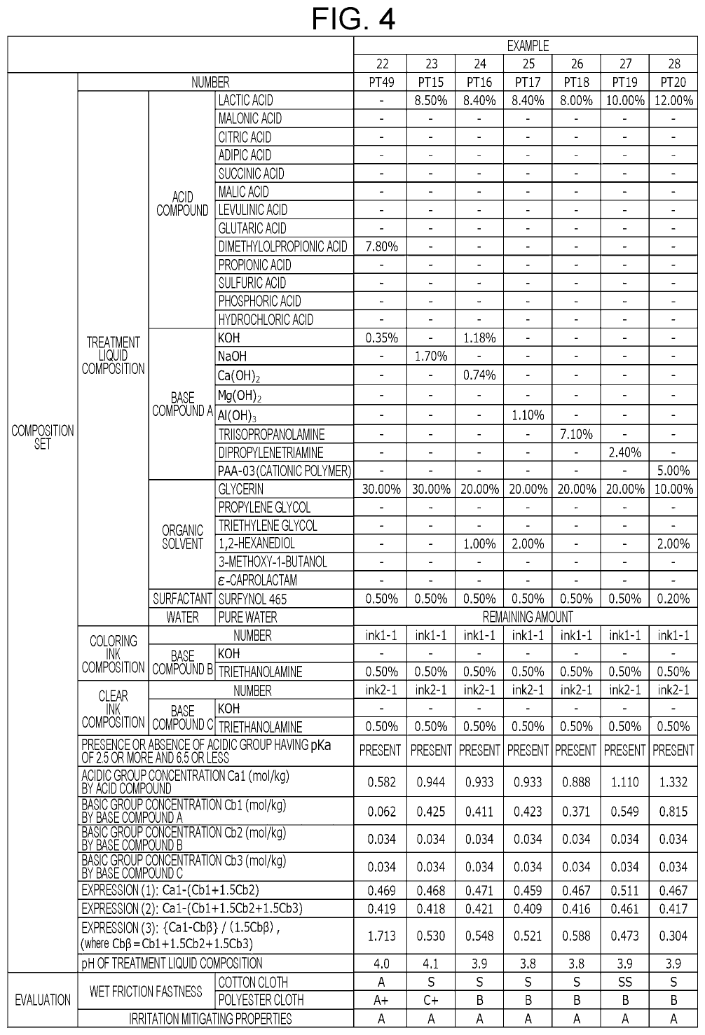

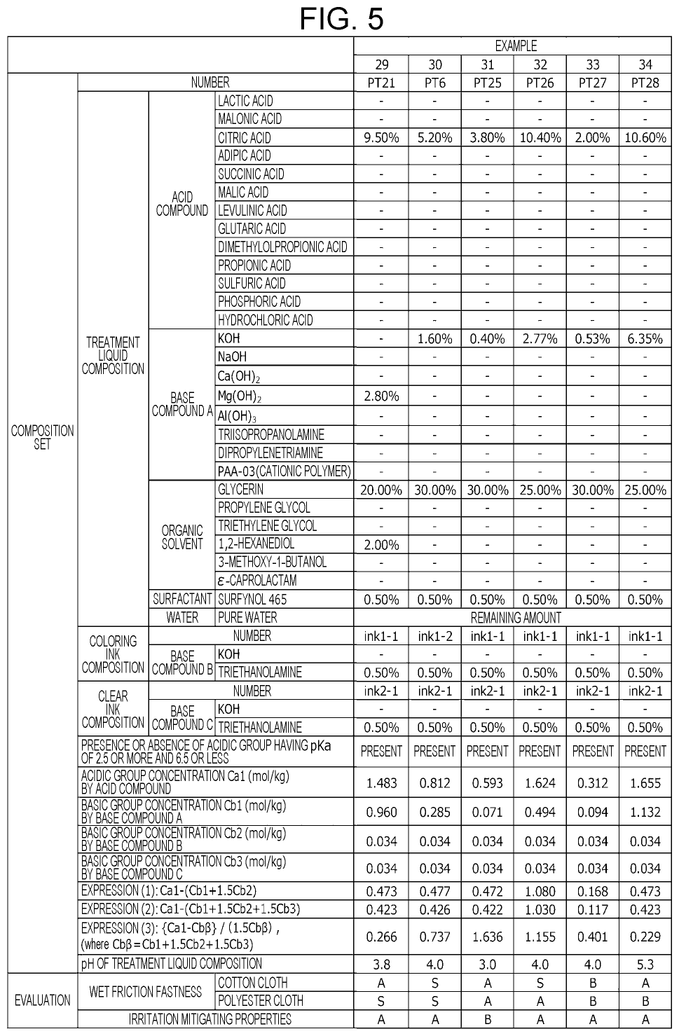

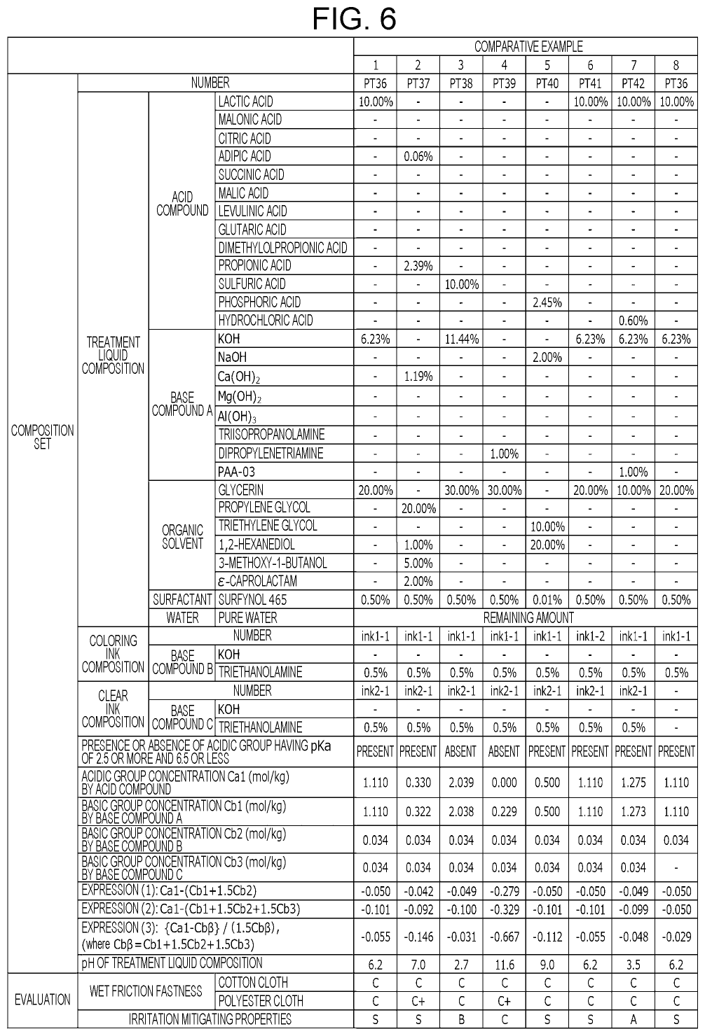

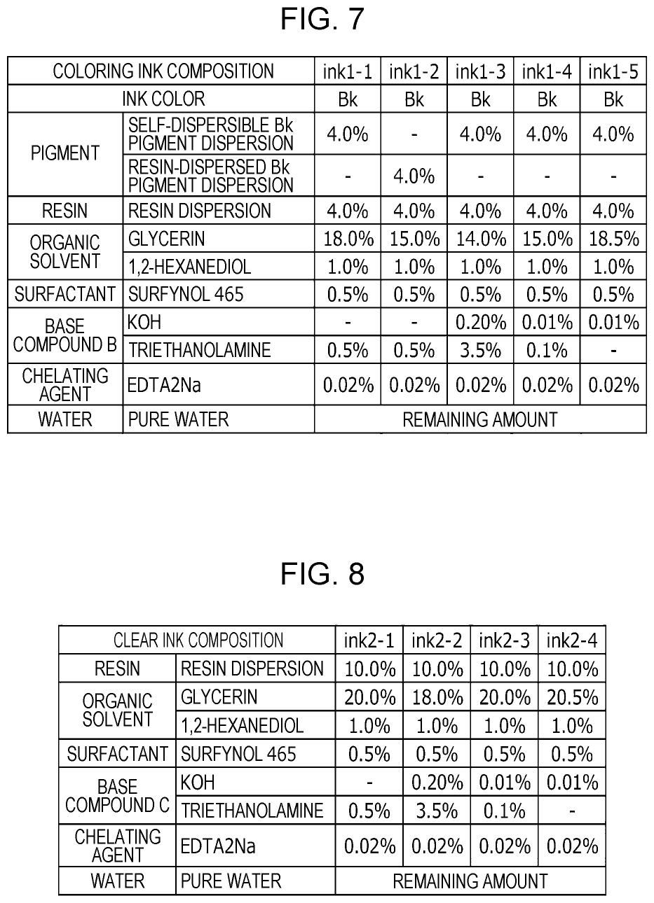

FIG. 1 to FIG. 8 describe Table 1 to Table 8 showing the compositions and/or the evaluation results of compositions in each composition set of Examples and Comparative Examples.

### 1. Preparation of Each Composition

The treatment liquid composition, the coloring ink composition, and the clear ink composition of each example were obtained by putting the components in a tank for a mixture so as to have the compositions described in Table 1 to Table 8, mixing and stirring the components, and further filtering the components with a membrane filter. Note that the numerical value of each component shown in each example in the tables is represented in terms of % by mass unless otherwise described. In addition, in the tables, the numerical value of each content is represented in terms of % by mass of the solid content of the active component.

The details of the abbreviations and product components used for each composition are as follows.

### 1.1. Preparation of Treatment Liquid Composition

### Acid Compound

Lactic acid (pKa=3.9, carboxy group, monovalent)
Malonic acid (pKa=2.8, 5.7, carboxy group, divalent)
Citric acid (pKa=3.1, 4.8, 5.4, carboxy group, trivalent)
Adipic acid (pKa=4.4, 5.4, carboxy group, divalent)
Succinic acid (pKa=4.2, 5.5, carboxy group, divalent)
Malic acid (pKa=3.4, 5.1, carboxy group, divalent)
Levulinic acid (pKa=4.6, carboxy group, monovalent)
Glutaric acid (pKa=4.1, 5.0, carboxy group, divalent)
Dimethylolpropionic acid (pKa=4.7, carboxy group, monovalent)
Propionic acid (pKa=4.7, carboxy group, monovalent)
Sulfuric acid (pKa=−2.0, 1.9, sulfo group, divalent)
Phosphoric acid (pKa=2.0, 6.8, 12.5, phosphoric acid group (divalent)
Hydrochloric acid (pKa<0, monovalent)

### Base Compound A

KOH (monovalent)
NaOH (monovalent)
Ca(OH)₂ (divalent)
Mg(OH)₂ (divalent)
Al(OH)₃ (trivalent)
Triisopropanolamine (amino group, monovalent)
Dipropylenetriamine (amino group, trivalent)
PAA-03 (cationic polymer) (polyallylamine, amino group, pH=11, manufactured by Nittobo Medical Co., Ltd., molecular weight per basic group calculated by the method described below: 61.385 g/mol)

### Organic Solvent

Glycerin
Propylene glycol
Triethylene glycol
1,2-Hexanediol
Triethylene glycol monobutyl ether
3-Methoxy-1-butanol
ε-Caprolactam

### Surfactant

Surfynol 465 (acetylene glycol, manufactured by Nissin Chemical Co., Ltd.)

### Water

Pure water

### 1.2. Preparation of Coloring Ink Composition

The details of each component shown in Table 7 are as follows.

### Pigment

Self-dispersible Bk pigment dispersion: A dispersion prepared by the following method was used.

Carbon black original powder prepared by the furnace method (primary particle diameter=18 nm, BET specific surface area=180 m²/g, DBP absorption amount=186 mL/100 g) in an amount of 500 g was added to 3,750 g of ion exchanged water, and the temperature was raised to 45° C. with stirring with a dissolver. After that, while pulverizing the carbon black with a sand mill using zirconia beads having a diameter of 0.8 mm, and 30,000 g of an aqueous solution of sodium hypochlorite (effective chlorine concentration=12%) was added dropwise thereto at 45° C. over 3.5 hours. Subsequently, pulverization with the sand mill was continued for further 30 minutes to obtain a treatment liquid containing a self-dispersible carbon black. This treatment liquid was filtered through a 400-mesh wire net to separate the zirconia beads and unreacted carbon black from the treatment liquid. A 5% aqueous potassium hydroxide solution was added to the treatment liquid obtained through the separation to adjust the pH to 7.5. Desalination and purification were then carried out using an ultrafiltration membrane until the electric conductivity of the liquid reached 1.5 mS/cm. Desalination and purification were then further carried out using an electrodialyzer until the electric conductivity of the liquid reached 1.0 mS/cm. The liquid was then concentrated until the concentration of the self-dispersible carbon black reached 17% by mass. This concentrate was subjected to a centrifugal separator to remove coarse particles, and filtered through a 0.6 μm filter. Ion exchanged water was added to the obtained filtrate, and the mixture was diluted until the concentration of the self-dispersible carbon black reached 15% by mass, and dispersed to obtain a self-dispersible Bk pigment dispersion.
Resin-dispersed Bk pigment dispersion: A pigment dispersion prepared by the following method was used.

Using 20 parts by mass of methyl ethyl ketone, 0.03 part by mass of 2-mercapto ethanol, a polymerization initiator, 15 parts by mass of polypropylene glycol monomethacrylate (propylene oxide group=9), 15 parts by mass of poly(ethylene glycol/propylene glycol) monomethacrylate (propylene oxide group=7, ethylene oxide group=5), 12 parts by mass of methacrylic acid, 50 parts by mass of a styrene monomer, 10 parts by mass of a styrene macromer, and 10 parts by mass of benzyl methacrylate, they were put into a reaction vessel sufficiently substituted with nitrogen gas, and polymerized with stirring at 75° C., 0.9 part by mass of 2,2′-azobis(2,4-dimethylvaleronitrile) dissolved in 40 parts by mass of methylethyl ketone with respect to 100 parts by mass of the monomer components was added thereto, and the mixture was aged at 80° C. for 1 hour to obtain a polymer solution.

The water-insoluble polymer obtained above in an amount of 7.5 parts by mass was dissolved in 45 parts by mass of methyl ethyl ketone, a predetermined amount of a 20% aqueous sodium hydroxide solution (a neutralizing agent) was added thereto to neutralize salt-forming groups, 20 parts by mass of carbon black as a pigment was further added thereto, and the mixture was kneaded with a bead mill for 2 hours. To the thus obtained kneaded product, 120 parts by mass of ion exchanged water was added and stirred, and then methyl ethyl ketone was removed at 6° C. under reduced pressure, and part of water was further removed to obtain a resin-dispersed pigment dispersion liquid having a solid content concentration of 20% by mass.

### Resin

Resin dispersion: A resin dispersion prepared by the following method was used.

Put into a four-neck flask equipped with a stirrer, a cooling tube, a nitrogen introduction tube, and a thermometer were 322.2 g of polytetramethylene ether glycol having a number average molecular weight of 1,000, 19.7 g of 2,2-dimethylolbutanoic acid, 16.9 g of 1,4-butanediol, 137.9 g of hexamethylene diisocyanate, and 344.0 g of methyl ethyl ketone, which were reacted at 80° C. in a nitrogen gas atmosphere for 6 hours. After that, cooling was performed to 60° C., 12.5 g of triethylamine was added thereto, and mixed for 30 minutes at this temperature. The obtained prepolymer was mixed with 1,146.7 g of deionized water, the resultant mixture was stirred for 2 hours, and then methyl ethyl ketone was subjected to solvent removal under reduced pressure at 40° C. to obtain a polyurethane resin dispersion having a carboxy group as an acidic group.

### Organic Solvent

Glycerin
1,2-Hexanediol

### Base Compound B

KOH (monovalent)
Triethanolamine

### Surfactant

Surfynol 465 (trade name, acetylene glycol-based surfactant, manufactured by Nissin Chemical Co., Ltd.)

### Chelating Agent

EDTA2Na (disodium dihydrogen ethylenediaminetetraacetate)

### Water

Pure water

### 1.3. Preparation of Clear Ink Composition

The details of each component shown in Table 8 are as follows.

### Resin

Resin dispersion: The same as the resin dispersion used in the preparation of the coloring ink composition described above was used.

### Base Compound C

KOH (monovalent)
Triethanolamine

### Organic Solvent

Glycerin
1,2-Hexanediol

### Surfactant

Surfynol 465 (trade name, acetylene glycol-based surfactant, manufactured by Nissin Chemical Co., Ltd.)

### Chelating Agent

EDTA2Na (disodium dihydrogen ethylenediaminetetraacetate)

### Water

Pure water

### 2. Calculation Methods

### 2.1. Methods for Calculating Ca1, Cb1, Cb2, and Cb3

The mass molarity Ca1 of the acidic group of the acid compound was calculated by the following expression.

Ca1=(addition amount[% by weight] of acid compound)×(number of acidic groups of pKa of 7or less in one acid molecule)×10/(molecular weight[g/mol] of acid compound)

The mass molarities Cb1, Cb2 and Cb3 of the basic groups of the base compounds were calculated by the following expression.

Cb=(addition amount[% by weight] of base compound)×(number of hydroxy groups or amino groups in one base molecule)×10/(molecular weight[g/mol] of base compound)

Note that in the case of an amphoteric compound such as an amino acid, the concentration was calculated in the same manner as described above in accordance with the properties of the group having a larger number based on the difference in the number of acidic groups and basic groups. For example, in the case of L-aspartic acid as an acidic amino acid, the concentration can be calculated as follows.

Aspartic acid has two carboxy groups (pKa=2.0 and 3.9) as the acidic group and one amino group as the basic group in one molecule, and an aqueous solution of aspartic acid has a pH of around 3. For aspartic acid as an acid compound, the mass molarity Ca of the acidic group can be calculated according to the following expression:

Ca=(addition amount[% by mass] of acid compound)×{(number of acidic groups having pKa of 7or less in one molecule of acid compound)−(number of basic groups in one molecule of acid compound)}×10/(molecular weight[g/mol] of acid compound)

It is as follows when the addition amount of aspartic acid is 10% by mass.

Ca=10×(2−1)×10/133.10≈0.751

Note that in the case of an amphoteric compound such as an amino acid, the concentration was calculated in the same manner as described above in accordance with the properties of the group having a larger number based on the difference in the number of acidic groups and basic groups.

2.2. Method for Calculating Molecular Weight and Valence of Compound of which Molecular Weight and Number of Acidic Groups (or Basic Groups) are Unknown

A compound of which the molecular weight and the number of acidic groups (or basic groups) are unknown in an amount of 0.30 g is dissolved in 29.70 g of pure water to prepare an amount of 30.00 g. The procedure of adding dropwise 0.03 g of a 10 wt % sodium hydroxide (or sulfuric acid) to the aqueous solution of the compound, stirring the resultant mixture with a magnetic stirrer, and then measuring the pH of the aqueous solution using a pH meter (F-72, manufactured by Horiba, Ltd.) was repeated, and it was determined that neutralization was achieved when the pH of the aqueous solution reached 8.0 (or 6.0), and the repeated operation was ended. From this result, an addition amount aₓ (or bₓ) (g) of the acid compound (or the base compound) required to neutralize 1 g of 100 wt % sodium hydroxide (or 1 g of sulfuric acid) was calculated using the following expressions.

aₓ=0.30 g/(addition amount (g) of 100 wt % sodium hydroxide)

bₓ=0.30 g/(addition amount (g) of 100 wt % sulfuric acid)

Here, (addition amount (g) of 100 wt % sulfuric acid)=(addition amount (g) of 10 wt % sulfuric acid)/10, and (addition amount (g) of 100 wt % sulfuric acid)=(addition amount (g) of 10 wt % sulfuric acid)/10.

Subsequently, a 1 wt % sulfuric acid aqueous solution (or 1 wt % sodium hydroxide aqueous solution) was subjected to the above-described operation to calculate an addition amount a_{H2S04} (g) (or b_{KOH} (g)) of sulfuric acid (or potassium hydroxide) required to neutralize 1 g of 100 wt % sodium hydroxide (or 100 wt % sulfuric acid), and the molecular weight (g/mol) per acidic group (or basic group) was calculated using the following expressions.

98.08×aₓ/a_{H2S04}

40.00×bₓ/b_{KOH}

### 3. Printing Method

Printing was performed by ejecting the treatment liquid composition and the coloring ink composition from a head in the same pass onto a 100% cotton white broad cloth (#4000, manufactured by Nisshinbo Industries, Inc.) or a polyester cloth using an apparatus obtained by modifying ML-8000 (manufactured by Seiko Epson Corporation), the main scanning was performed a plurality of times (2 times, 4 times, 8 times, 12 times, or 16 times) on the same scanning region, and subsequently, the clear ink composition was printed in the same manner, thereby forming a 20 cm×5 cm solid pattern image on the cloth as a recording medium.

The adhesion amount of each composition to the cotton cloth was set to 15 mg/inch² for the treatment liquid composition, 30 mg/inch² for the coloring ink composition, and 15 mg/inch² for the clear ink composition. The adhesion amount of each composition to the polyester cloth was set to 20 mg/inch² for the treatment liquid composition, 30 mg/inch² for the coloring ink composition, and 30 mg/inch² for the clear ink composition. After image formation, a heating treatment was performed at 160° C. for 5 minutes in an oven to dry the cloth, thereby producing a textile printed matter of each example and each comparative example. Note that the “solid pattern image” means an image in which dots are uniformly formed on the entire surface of the recording region (main scanning direction×sub-scanning direction: 20 cm×5 cm) such that the application amount of each liquid is the above-described numerical value.

Note that for the ink jet head, a head unit in which an inter-nozzle distance in the sub-scanning direction was 600 dpi and two head chips were disposed in the sub-scanning direction to have a nozzle length of 2 inches was used.

### 4. Evaluation Methods

### 4.1. Wet Friction Fastness (Cotton Cloth and Polyester Cloth)

A textile printed matter was created on each of the cotton cloth and the polyester cloth using the above-described printing method. Against this, the image of the textile printed matter was rubbed 10 times with a load of 9 N with unbleached muslin (a white cotton cloth) using a clock meter (FI-306, manufactured by Tester Sangyo Co., Ltd.). Thereafter, for the region contaminated with the ink of the rubbing unbleached muslin, the optical density (OD, Status E) of black of the printed image was measured using a colorimeter (FD-7, manufactured by Konica Minolta, Inc.), and evaluated according to the following criteria.

### Evaluation Criteria for Printing on Cotton Cloth

SS: OD is 0.22 or less.
S: OD is greater than 0.22 and 0.31 or less.
A: OD is greater than 0.31 and 0.4 or less.
B: OD is greater than 0.4 and 0.5 or less.
C: OD is greater than 0.5.

### Evaluation Criteria for Printing on Polyester Cloth

SS: OD of black is 0.22 or less.
S: OD of black is greater than 0.22 and 0.29 or less.
A+: OD of black is greater than 0.29 and 0.36 or less.
A: OD of black is greater than 0.36 and 0.40 or less.
B: OD of black is greater than 0.40 and 0.47 or less.
C+: OD of black is greater than 0.47 and 0.53 or less.
C: OD of black is greater than 0.53.

### 4.2. Irritation Mitigating Properties

From the textile printed matter created on the cotton cloth by using the above-described printing method, a printed image with an area of 15 cm×3.2 cm was cut, which was cut into small pieces with a width of 5 mm, which were put into a glass bottle together with 35 mL of pure water. Next, extraction was performed by stirring for 2 hours using a magnetic stirrer. After that, the pH of the extracted liquid was measured using a pH meter (F-72, manufactured by Horiba, Ltd.). This operation was repeated three times, and evaluation was performed according to the following criteria based on the average of the measured pH values.

### Evaluation Criteria

S: The average of pH is 4.7 or more.
A: The average of pH is 4.4 or more and less than 4.7.
B: The average of pH is 4.2 or more and less than 4.4.
C: The average of pH is less than 4.2.

What is claimed is:

1. An ink jet composition set comprising a treatment liquid composition and a coloring ink composition, wherein
the treatment liquid composition contains an acid compound and water,
the treatment liquid composition contains or does not contain a base compound A,
the coloring ink composition contains a pigment, resin particles, a base compound B, and water, and
a molarity Ca1 (mol/kg) of an acidic group by the acid compound, a molarity Cb1 (mol/kg) of a basic group by the base compound A, and a molarity Cb2 (mol/kg) of a basic group by the base compound B satisfy Expression (1) below:
Ca1−(Cb1+1.5Cb2)≥0.10(mol/kg) Expression (1)
where Ca1>0, Cb1≥0, and Cb2>0.

2. The ink jet composition set according to claim 1, wherein the acid compound contains one or more selected from the group consisting of lactic acid, acetic acid, levulinic acid, malic acid, malonic acid, citric acid, glutaric acid, phosphoric acid, and dimethylolpropionic acid.

3. The ink jet composition set according to claim 1, wherein
the treatment liquid composition has a pH of 2.5 or more and 6.5 or less, and
the coloring ink composition has a pH of greater than 6.5.

4. The ink jet composition set according to claim 1, wherein the acid compound has a pKa in water at 25° C. of at least 2.2 or more and 6.5 or less.

5. The ink jet composition set according to claim 1, wherein Cb1 is 0.01 or more.

6. The ink jet composition set according to claim 1, further comprising a clear ink composition, wherein
the clear ink composition contains resin particles, a base compound C, and water, and
Ca1, Cb1, Cb2, and a molarity Cb3 (mol/kg) of a basic group by the base compound C satisfy Expression (2) below:
Ca1−(Cb1+1.5Cb2+1.5Cb3)≥0.10(mol/kg) Expression (2)

7. The ink jet composition set according to claim 6, wherein Ca1, Cb1, Cb2, and Cb3 satisfy Expression (3) below:
{Ca1−(Cb1+1.5Cb2+1.5Cb3)}/1.5(Cb1+1.5Cb2+1.5Cb3)≥0.01 Expression (3)

8. The ink jet composition set according to claim 6, wherein Cb2 and Cb3 are each 0.35 mol/kg or less.

9. The ink jet composition set according to claim 6, wherein Ca1, Cb1, Cb2, and Cb3 satisfy Expression (4) below:
Ca1−(Cb1+1.5Cb2+1.5Cb3)≥0.15(mol/kg) Expression (4)

10. The ink jet composition set according to claim 6 wherein Ca1, Cb1, Cb2, and Cb3 satisfy Expression (5) below:
{Ca1−(Cb1+1.5Cb2+1.5Cb3)}/1.5(Cb1+1.5Cb2+1.5Cb3)≥0.20 Expression (5)

11. The ink jet composition set according to claim 6, wherein the base compound A, the base compound B, and the base compound C contain one or more selected from an alkaline metal hydroxide, alkaline earth metal hydroxide, and an amine compound.
